(19) United States
(12) Patent Application Publication
(10) Pub. No.: US 2003/0064705 A1
(43) Pub. Date: Apr. 3, 2003

(54) Communication of real estate information utilizing moving map GPS and wireless telecommunications to access MLS and other property specific information from remote databases

(76) Inventor: Piero L. Desiderio, Boca Raton, FL (US)

Correspondence Address: Mark D. Bowen, Stearns Weaver Miller, Suite 1900, 200 East Broward Boulevard, Fort Lauderdale, FL, 33301, US

(21) Appl. No.: 10/072,344

(22) Filed: Feb. 7, 2002

Related U.S. Application Data
(60) Provisional application No. 60/326,582, filed on Oct. 2, 2001.

(51) Int. Cl. H04B 7/00

(52) U.S. Cl. 455/412; 455/66; 455/456; 455/457

(57) ABSTRACT

A real estate information system and method is disclosed wherein a portable electronic device is enabled with moving map GPS refined to enable the identification of individual properties. The present invention seamlessly combines and integrates moving map GPS technology with a database supplemented to include location and address information for identifying real estate properties. The invention further includes wireless communications specifically configured for obtaining property-specific MLS information, and other related data compiled and maintained by third parties. A portable electronic device, such as a portable computing device, or vehicle navigational apparatus is enabled with integrated GPS and wireless communications technology specifically adapted for identifying specific properties and displaying corresponding property related data and information electronically accessed from remote sources via wireless communications. The system thus provides a GPS enabled PED for use in the field by brokers, and market participants, to identify and evaluate properties.

### CROSS-REFERENCE TO RELATED APPLICATIONS

This application claims the benefit of U.S. provisional application No. 60/326,582, filed Oct. 2, 2001.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights.

### BACKGROUND OF THE INVENTION

1. Field of the Invention

The present invention relates to wireless telecommunications systems, and more particularly to a wireless real estate information and telecommunications system that enhances global positioning system (“GPS”) technology to display, on a portable wireless electronic device (“PED”), individual property locations and addresses in relation to the PED'S location. The system further integrates and combines this enhanced GPS system with multiple listing service (“MLS”) databases, property tax appraiser's database, and information from other real estate related databases and sources to allow the user to select a property by graphical, or other interface, and thereby automatically access all real estate related databases and sources of information relating to the selected property.

2. Background of the Invention

The purchase and sale of real estate requires real-time access to the latest, up-to-date real estate information. In order to fully advise their clients, real estate brokers and salespersons require instant, on-the-spot access to real estate related information for specific properties in the field. In addition, buyers, sellers, and other market participants can also benefit from instant access to real estate related information for specific properties. Among the information considered necessary in real property transactions is the property address, legal description, tax folio number, MLS information, comparable sales records and data, real property tax information, photographs and virtual tours of the property, tax records, public records reflecting mortgages, judgments and other liens, and a variety of other data and information relative to a particular property. This information, however, is not readily accessible, nor is it maintained by a single source. Rather, the information is often compiled and/or maintained by separate entities and organizations such as the local county property appraiser, associations of real estate professionals, and other third parties. The ability to graphically display the location and address of properties in relation to the PED, while providing the user with a graphical interface input means suitable for selecting individual properties displayed on a PED, and, in turn providing wireless electronic access to real estate information obtained from remote databases, while in the field, presents a significant advantage to real estate brokers, salespersons, mortgage brokers, buyers, sellers, and other market participants.

The prior art reveals a number of attempts to address this long-standing need. For example, U.S. Pat. No. 5,664,115, issued to Fraser, discloses a system for automatically matching sellers of property with potential buyers through a communications network, such as the Internet, in which a host system communicates with the sellers and potential buyers over data transmission lines. The host system obtains and stores a first set of records each corresponding to a property to be sold. The records may then be searched by a remote data terminal associated with a potential buyer. U.S. Pat. No. 6,148,260, issued to Musk et al., discloses a network accessible service which integrates both a business directory and a map database and enables searching for businesses in a variety of methods. U.S. Pat. No. 6,199,099, issued to Gersham et al., discloses a mobile computing system for accessing the Internet to obtain product information for a user utilizing a distributed communication network and hand-held wireless devices. U.S. Pat. No. 6,236,977, issued to Verba et al., discloses a system implemented using computer network and web-based technology to match buyers and sellers. U.S. Pat. No. 6,252,544, issued to Hoffberg, discloses a mobile communications device comprising a location sensing system, a memory storing a set of locations, a telecommunications device for communicating event and location information between a remote system and memory, and a processor for processing location output in conjunction with stored locations and associated events. U.S. Pat. No. 6,321,158, issued to DeLorme et al., discloses a routing and mapping information system that links personal computer cartographic applications to handheld organizers and personal digital assistants (PDA) or palmtop devices, which devices are preferably equipped with, or connected to, portable Global Positioning Systems (GPS) or equivalent position sensing devices. U.S. Pat. No. 6,321,202, issued to Raveis, Jr., discloses a system and method for managing real estate transactions. Raveis, Jr. teaches a receiving and storing data relating to a plurality of contacts including buyers and sellers of real estate, receiving and storing data relating to a plurality of vendors, and accessing and communicating data relating to the vendors to a contract upon occurrence of a particular phase of the real estate transaction. U.S. Patent Application Publication No. U.S. 2001/0031640 discloses a method of accessing information on an information network by a mobile communications device, wherein the information supplied to a user is tailored according to the geographical location of the device. In addition, it is known in the art of global positioning systems (GPS) to obtain theoretical property locations by calculating the approximate location of a property from street address information, such as address information based on the distances between intersecting streets. It is believed that such technology is used by the Internet website www.mapquest.com to provide users with approximate locations for specific addresses.

The prior art, however, fails to adequately address the shortcomings present in the field of real estate transactions. Specifically, the prior art fails to either teach or suggest a system for use by brokers and other market participants that integrates moving map GPS, enhanced with data so as to be capable of displaying the actual locations and addresses of properties in relation to the user's PED, with private and public databases to enable remote electronic access to a wide variety of property specific information. More particularly, the prior art fails to disclose a wireless real estate information system including a PED enabled with GPS technology, enhanced to display the locations and addresses of properties in relation to the user's PED, that provides a user, such as a broker or other market participant, with a portable wireless device for integrating electronic access to remotely stored information and data including MLS information, property assessor's data, tax records, comparable sales data and analysis, public records reflecting mortgages, judgments and liens, as well as photographs and virtual tours corresponding to specific properties identified by street address. Since brokers and other market participants depend on access to real estate information there exists a need for a mobile wireless telecommunications system that utilizes GPS mapping technology that is refined to enable the identification and selection of specific real property by use of graphical depictions and/or icons supplemented by local street address such that market participants may access MLS databases and a host of other real estate related information such as comparable sales data, property appraiser's data, digital images, and broker/agent information and e-mail.

### Definitions

Global Positioning System (“GPS”) means a system of satellites, computers, and receivers that enable an Earth-based electronic device to reflect navigational and/or positional output data by calculating the time difference for signals from different satellites to reach the receiver.

Market Participants means real estate brokers and sales persons, business brokers, mortgage brokers, bankers and lenders, appraisers, developers, buyers and sellers of real estate, attorneys, city officials, land use consultants, architects, engineers and other persons and entities having an interest in real property.

Multiple Listing Service (“MLS”) means an arrangement among members of a real estate board or exchange that allows each member broker to share listings with other members so that greater exposure is obtained for maximizing sales.

Portable Electronic Device (“PED”) means a portable/mobile, wireless usually pen and/or stylus based computer, such as a PC tablet, laptop, notebook, vehicle navigation system, or any other personal electronic device.

Property Appraiser refers to County authorities responsible for assessing property, collecting data using specific forms and recording procedures. The information obtained is then processed through a computer, using appropriate valuation formulas to render an objective estimate of assessed value, which is utilized in establishing a property's assessed value for real estate tax purposes.

### BRIEF SUMMARY OF THE INVENTION

The present invention provides a system and method for seamlessly combining and integrating moving map GPS technology adapted for identifying real estate properties with wireless communications specifically configured for obtaining property-specific MLS information, and other real estate related data compiled and maintained by third parties. A Portable Electronic Device (“PED”), such as a personal digital assistant, pc tablet, portable computing device, or vehicle navigational apparatus is enabled with integrated GPS and wireless communications technology to display the locations and addresses of properties in relation to the system's PED and to allow the user to select a property or properties and immediately and remotely access and display all real estate related data and information via wireless electronic communication with remote data sources. The system thus provides a GPS enabled Portable Electronic Device for use in the field by brokers and other Market Participants, to identify and evaluate properties.

In a preferred embodiment, a PED is enabled with GPS capabilities and two-way wireless communications for electronically accessing and receiving real estate related information for properties in any geographic area, and particularly in an area in proximity to the user/device. The PED includes integral GPS capabilities and moving map navigational display features, adapted to display the location and street address associated with individual properties (e.g. property addresses), which information is used to identify and select particular properties of interest to the broker or other Market Participant.

The present invention contemplates enhancing current GPS technology with actual geographical position coordinates for individual properties. The enhancement may be accomplished by field surveys utilizing GPS receivers to match GPS coordinates with actual property addresses. In an alternate embodiment, the enhancement may be accomplished using aerial imagery and known GPS coordinates for certain landmarks so as to obtain GPS coordinates for individual properties. The enhancement of GPS technology to enable a system to identify the actual locations of individual properties is an important aspect of the present invention as the use of theoretical locations currently relied on in the art fails to provide the accuracy required to accurately identify individual properties, particularly in high density areas.

Upon selection of a particular property, the property's address (and, if necessary, the property's legal description and tax folio number) is used to electronically access property-related data via wireless electronic communication with databases maintained by third parties. Equipped with a PED as disclosed herein, a broker is able to quickly access MLS information (e.g. list price, square footage, number of rooms, broker/agent contact information, etc.), tax information, sales history, county title documents, judgments, liens, and comparable sales for properties in proximity to the selected property, via wireless electronic access to, and interface with, remote databases.

The present invention thus provides a mobile wireless real estate information system for use by real estate brokers and other Market Participants.

It is an object of the present invention to provide a portable electronic device having integral moving map GPS and wireless communication functions that enable access to real estate MLS information.

Another object of the present invention is the integration of real estate related data from multiple remote data sources for access and use by a broker or other Market Participant in the field while prospecting for properties.

Yet another object of the present invention to provide a system and method configured and enabled for wireless data communications adapted to receive real estate information for user selected properties.

Still another object of the present invention is to provide a wireless communications system enabled with GPS positional data and automated communications functions to facilitate access to real estate related information for properties within proximity of the user via a Portable Electronic Device.

Yet another object of the present invention is to provide a Portable Electronic Device adapted with GPS and wireless communications software for obtaining real estate related information from various remote databases.

Still another object of the present invention is to refine GPS technology and databases to enable identification of individual properties.

In accordance with these and other objects that will become apparent hereinafter, the instant invention will now be described with particular reference to the accompanying drawings.

### BRIEF DESCRIPTION OF THE SEVERAL VIEWS OF THE DRAWINGS

FIG. 1 is a schematic block diagram depicting a preferred embodiment real estate information system according to the present invention;

FIG. 2 depicts a Portable Electronic Device according to the present invention in a moving map mode wherein individual properties are displayed;

FIG. 3 depicts the device in a property selection mode wherein properties may be identified and selected by street address;

FIG. 4 depicts the device in an MLS mode wherein MLS information and photographs corresponding to a selected property are displayed;

FIG. 5 depicts the device in a mode wherein information compiled and maintained by the local property appraiser is displayed;

FIG. 6 depicts the device in a comparables mode wherein information compiled and maintained by a third party relating to comparable sales information for surrounding properties is maintained;

FIG. 7 illustrates an alternate embodiment, touch screen device in a log-in mode;

FIG. 8 illustrates the touch screen device in a GPS moving map mode wherein individual properties are identified by street address; and

FIG. 9 illustrates the touch screen device in a property confirmation mode wherein a specific property is confirmed by street address and information options are presented.

### DETAILED DESCRIPTION OF THE INVENTION

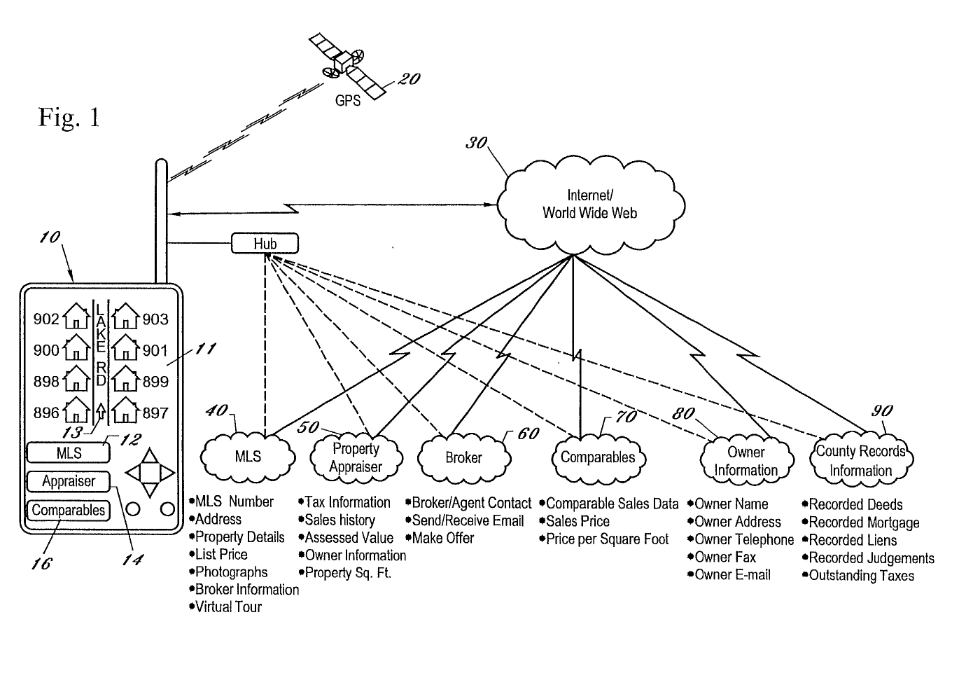

With reference now to the drawings, there is depicted a system and method for seamlessly combining and integrating a refined moving map GPS system, MLS information, and data maintained by a property appraiser and/or other third parties. A Portable Electronic Device (“PED”) is adapted to provide brokers, salespersons, prospective real estate buyers, sellers, and other Market Participants with access to said information. FIG. 1 depicts a block diagram of a system according to the present invention. A PED 10, having an electronic display 11, is enabled with moving map GPS technology and two-way wireless communications for receiving real estate related information for properties in any given geographic area. Device 10 may comprise a vehicle navigation unit, a portable computer, pc tablet, or any other compact electronic device adapted with a display capable of use with a moving map GPS and two-way wireless communications. Device 10 may further include a sound card for audible output of information, and a credit card reader for functional reasons disclosed herein.

In a preferred embodiment, a GPS system, generally referenced as 20 obtains earth-relative positioning information by electronic communication with GPS satellites in accordance with GPS communication protocols. A GPS database is supplemented and refined to define individual residential, commercial, and industrial properties by corresponding street address. A moving map display 11 functions to generate a visual display that is complete with street identifications and specific property address information. As noted above, the present invention contemplates enhancing current GPS technology with actual geographical position coordinates for individual properties. The enhancement may be accomplished by field surveys utilizing GPS receivers to obtain GPS coordinates for actual properties and corresponding property addresses. In an alternate embodiment, the enhancement may be accomplished using aerial imagery of cities, towns, and/or neighborhoods and known GPS coordinates for certain landmarks so as to precisely obtain GPS coordinates for individual properties. The enhancement of GPS technology to enable a system to identify the actual locations of individual properties is an important aspect of the present invention as the use of theoretical locations currently relied on in the art fails to provide the accuracy required to accurately identify individual properties, particularly in high density areas.

Device 10 is further configured with touch screen that enables the user to select a specific property via graphical user interface reference to conventional map graphics and/or street address. More particularly, the moving map GPS preferably generates and displays street map graphics, property icons, and corresponding addresses as illustrated in FIG. 1. In addition, an icon 13 depicts the location of device 10 relative to the surrounding area and properties. The use of graphical user interface technology is considered significant in rendering the technology user friendly. Specifically, the use of a moving map display with property icons allows the user to identify and select particular properties of interest for further evaluation.

As best depicted in FIG. 1, device 10 is enabled with wireless two-way telecommunications and integrated software for facilitating wireless access to the Internet, generally referenced as 30, whereby databases maintained by various third parties may be accessed, and data relating to any particular selected property may be accessed and downloaded. The present invention contemplates communicating with, and obtaining data from, a number of remote databases. For example, an MLS database 40, maintained by the National Association of Realtors and/or local Realtor associations, provides a variety of information relating to the target property including list price, square footage, number of rooms, interior and exterior digitized images, broker contact and other related information. A Property Appraiser's database 50 may be accessed to obtain tax information, sales history, assessed values, aerial photographs, property square footage, and owner information. In addition, the broker web site 60 may be accessed such that the user may obtain broker/agent contact information, e-mail access, and make an offer to purchase a property. Furthermore, a comparable sales database 70 is accessible for obtaining sales histories for surrounding and/or related properties. The present invention further contemplates accessing owner information 80, whereby the user may obtain owner name, address, telephone, fax, and e-mail. Finally, the invention is adapted to access a County Records database 90, for obtaining recorded deeds, mortgages, liens, judgments, and outstanding taxes. The present invention thus provides a mobile wireless information system specifically adapted for use in connection with real estate. The invention is particularly useful to real estate brokers and sales persons, business brokers, mortgage brokers, bankers and lenders, appraisers, developers, buyers and sellers of real estate, contractors, real estate and other attorneys, city officials, land use consultants, surveyors, architects, engineers, and other persons and entities involved in real estate.

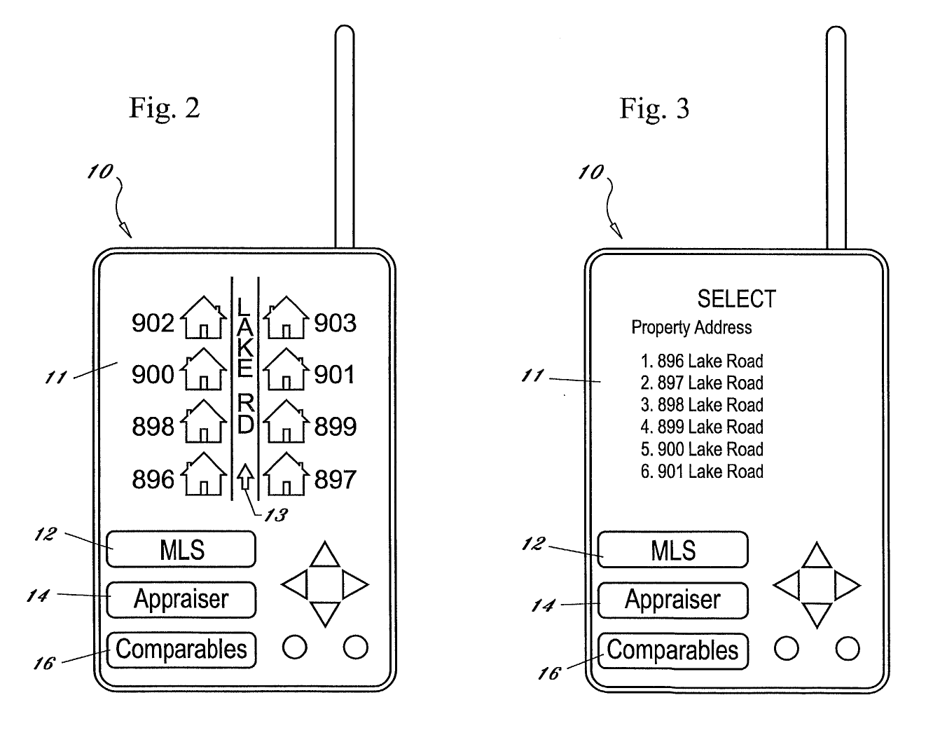

FIGS. 2-6 illustrate functional aspects of the present invention and provide an example of the means by which data is obtained for the user. In accordance with the example, a real estate broker with an electronic device 10 is driving through a residential community and pulls up to a residential property advertised as being “For Sale”. As best illustrated in FIG. 2, the moving map GPS displays individual properties and address information. In addition, an icon 13 corresponding to the position of device 10 confirms the position of the user relative to the surrounding area, while particularly identifying those properties that are available for sale or lease. The user may select a particular property by graphical interface (e.g. click on location via touch pad, stylus, or mouse type interface) or by scrolling through and selecting a target property from a list of surrounding addresses as depicted in FIG. 3.

Once a given property is selected, PED 10 automatically seeks and receives information relating to the selected property via wireless communications, such as wireless Internet access or wireless communication with a dedicated communications hub as illustrated in FIG. 1. As noted hereinabove, a particular property may be selected by graphical point-and-click on a screen depicted in FIG. 2, or by scrolling street addresses as depicted on a screen as seen in FIG. 3. In any event, once selected various property specific information may be rapidly obtained via wireless communications.

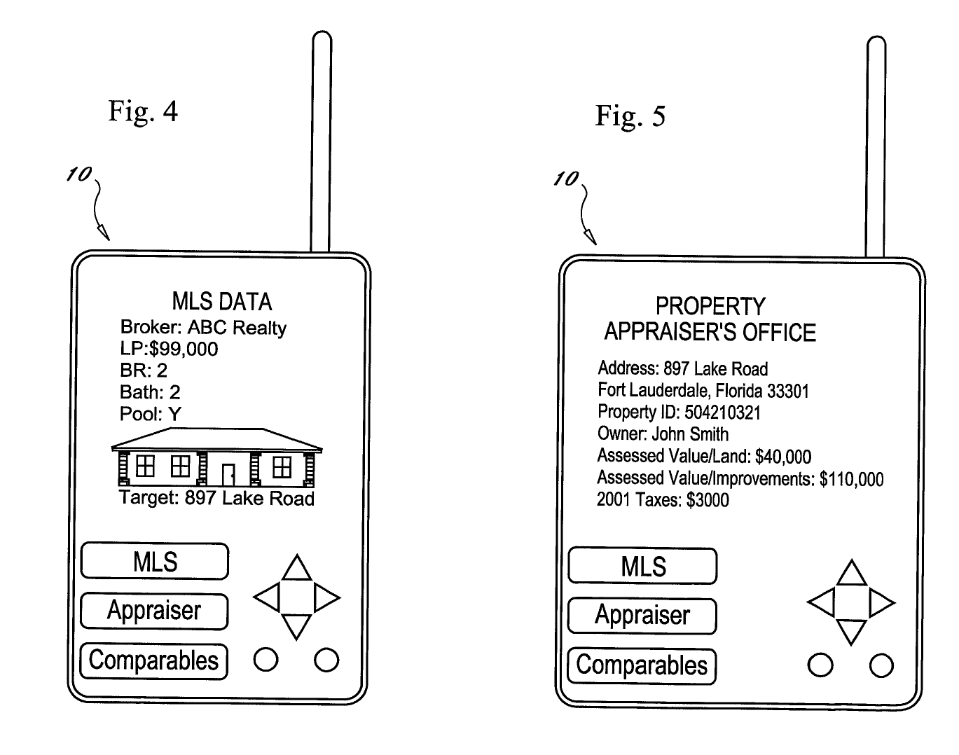

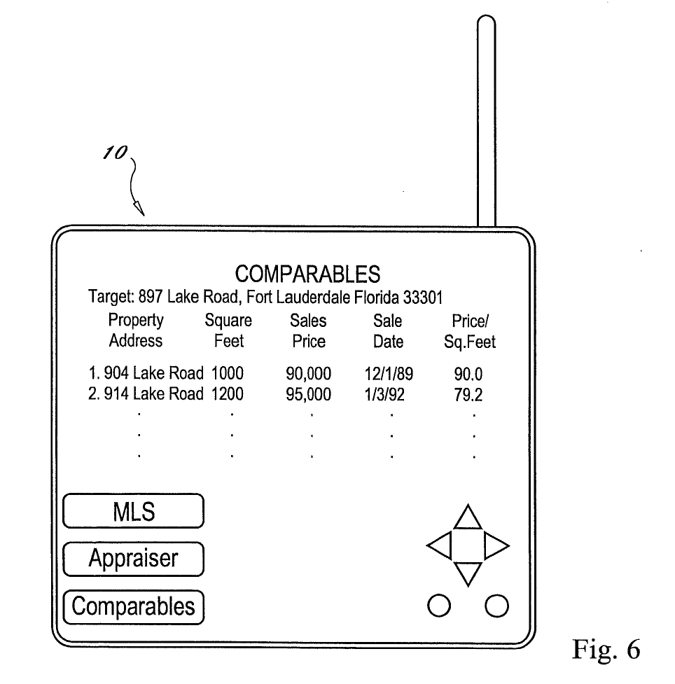

FIGS. 4-6 illustrate the display of information received from various property related databases in accordance with the present invention. As best depicted in FIG. 4, MLS information may be accessed and obtained from an MLS database compiled and maintained by the National Association of Realtors and/or the relevant local Realtor Association. FIG. 4 illustrates but one possible display of information associated with the selected property, which property is identified as the “target property” having an address of 897 Lake Road. As should be apparent, the present invention contemplates the accessing and display of any suitable property specific information from the MLS database, including MLS number, list price, Broker/Agent information, etc. FIG. 5 illustrates the presentation of selected information for the target property obtained by wireless communication with a database maintained by the local Property Appraiser's Office. The user is thus able to access the property identification number (e.g. folio number), owner records, assessed values of the land and improvements, property square footage, and property tax information. FIG. 6 illustrates the presentation of comparables sales histories for comparable properties in proximity to the target property. The comparables information is obtained from information compiled and maintained by a third party relating to comparable sales information.

Device 10 is preferably configured to seek and receive the above-referenced information with a minimum number of required keystrokes or graphical user interfaces. Thus, in a preferred embodiment, device 10 is configured with dedicated user interface command “buttons,” which transmit and receive corresponding property information upon activation. Among the dedicated features are command buttons corresponding to MLS information 12, Property Appraiser information 14, and Comparables information 16, each of which are configured to access and display information for the selected property with the single push of a corresponding button. Device 10 is preferably configured with communication software including wireless transmission code which eliminates the need for further user input in order to obtain the desired information. The buttons are preferably presented as graphical user interface (“GUI”) on an electronic touch display. Device 10 may be further configured to allow the user to send wireless e-mail directly to the listed broker and/or sales agent. In a similar manner, other real estate related information may be obtained from various databases maintained by third parties.

As further depicted in FIG. 1, data may be accessed through a global computer network known as the Internet and World Wide Web, or directly through a communications hub (“hub”) specifically maintained to provide access to a number of portable devices on a regional and/or national scale. Accordingly, the communications hub may facilitate communications with a plurality of remote devices 10 using proprietary communication protocols developed for this specific application. Device 10 may be further configured to allow the user to send wireless e-mail directly to the listing broker and/or sales agent. In a similar manner, other real estate related information may be obtained from various databases maintained by third parties.

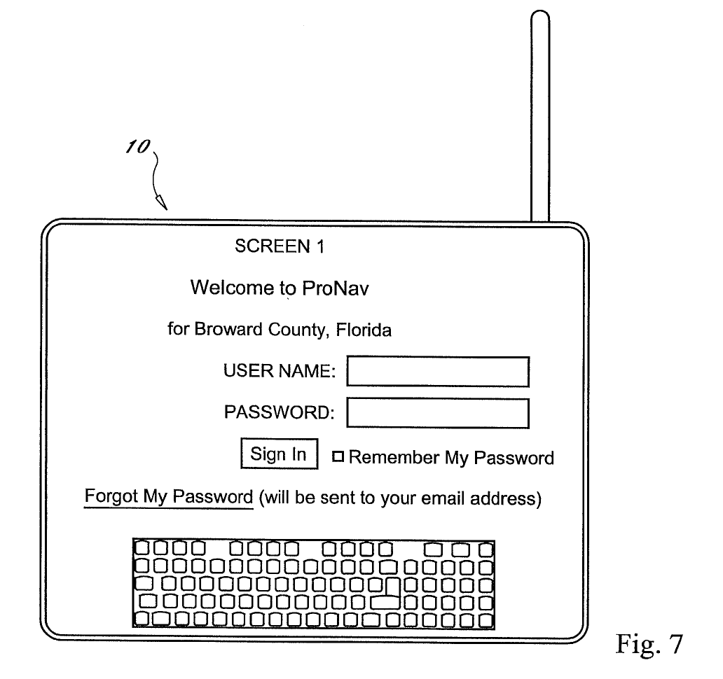

FIG. 7 illustrates an alternate embodiment display for device 10 incorporating a full-screen display 11 wherein input and output interface in accomplished by graphical user interface (“GUI”) technology adapted for use on a full-screen enabled portable electronic device. Accordingly, FIG. 7 depicts a full-screen apparatus wherein input keys are graphically displayed to represent and operate as a functional keyboard. An advantage realized by this use of technology is the ability to modify and adapt graphical user interface options by software modification. A stylus or other suitable pointing device may be used to activate desired input keys. As best depicted in FIG. 7, a log-in screen enables the user to access the proprietary telecommunications modes enabled by the system. As further depicted in FIG. 7, user access may be limited by incorporating a front-end log-in screen that limits access to authorized users by requiring user input of a user name and password. As should be apparent, minor modifications of the log-in screen should be considered within the scope of the present invention.

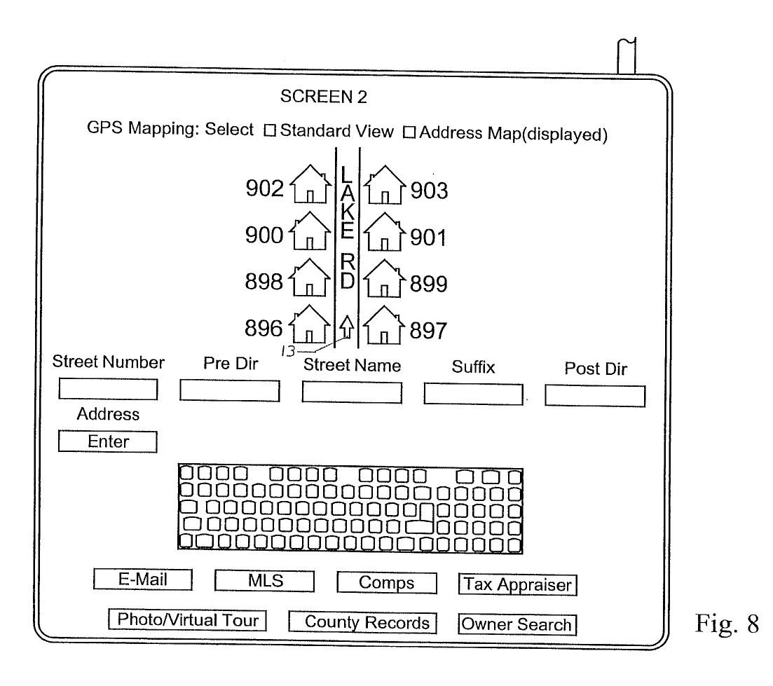

FIG. 8 illustrates a street level map view wherein individual properties are identified by street address utilizing GPS technology. A significant aspect of the present invention involves the refinement of current GPS technology to display each property's location, its street address, and to incorporate more fully defined street address information for each property (e.g. postal address) thereby enabling the identification and selection properties based on conventional address information. In view of the current state of the art, a significant aspect of the present invention includes improvements in the art of GPS technology to produce a GPS database wherein individual GPS coordinates are linked to actual property addresses and locations to identify individual properties and, via wireless communication, property-related information. Thus, as seen in FIG. 8, individual properties may be identified and selected by reference to the output display. More particularly, the GPS map views may be displayed in a standard view format wherein street names (but not individual property addresses) are displayed or an address view format wherein individual property addresses are displayed. As best illustrated in FIG. 8, the address of a specific property may be selected by the user by “point and click” graphical user interface whereafter the property address may be displayed (e.g. 897 Lake Road) for confirmation by the user.

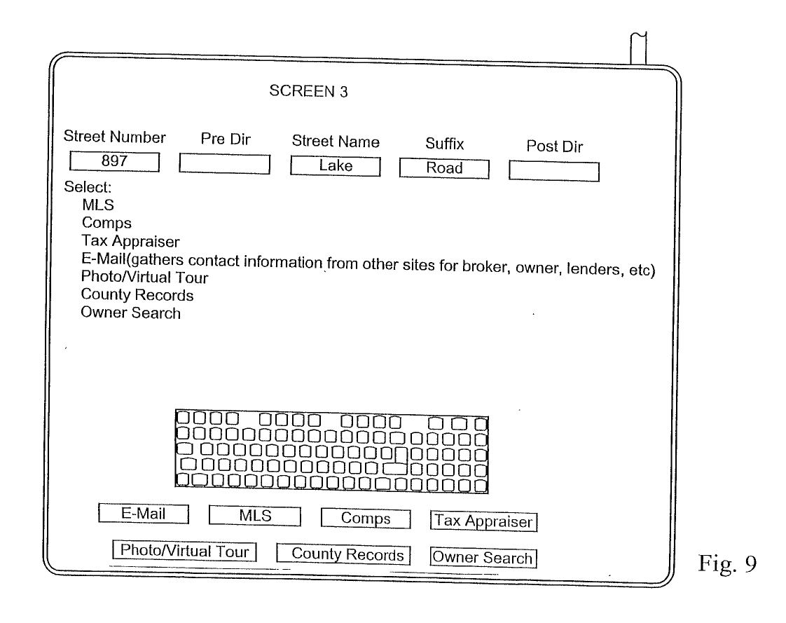

Once a property is identified, selected, and confirmed a host of available information options may be displayed as shown in FIG. 9. More particularly, FIG. 9 illustrates a property confirmation screen wherein a specific property is confirmed by street address and information options are presented such that the user may obtain information relating to MLS, comparables, tax appraiser, aerial views, virtual tours, county records, and broker e-mail via wireless access. As depicted in FIG. 9, the identification of the selected target property is confirmed by displaying the property address for confirmation by the user. Once the address of the property is confirmed, wireless telecommunication capability provides access to various real estate related databases, such as MLS, comparables information, tax appraiser databases, county records, aerial and virtual tours (utilizing digitized images stored in remotely accessed databases), as well as e-mail access to listing brokers/agents.

The instant invention contemplates further capabilities intended to enhance the communication of real estate related information. For example, device 10 may further include data storage capability whereby form contracts for the purchase and sale of real property may be stored. The form contracts may be “opened” for display on the device such that information corresponding to the target property is used to automatically complete a contract and/or offer for the purchase of the target property. Once completed, the contract and/or offer may be e-mailed directly to the listing broker or property owner. In addition, the device may be preferably configured for transmitting a good faith deposit to the listing broker by prompting the user for credit card information sufficient for completion of an electronic transaction whereby funds are credited to the broker's escrow account.

The present invention thus provides a remote, wireless telecommunications system and method specifically adapted for use by real estate brokers, buyers, sellers, and other Market Participants to enable remote access to data and information for a particularly selected property. The access to the information described herein allows interested parties to immediately access and evaluate real estate related information thus aiding in the efficient purchase and sale of real property.

The instant invention has been shown and described herein in what is considered to be the most practical and preferred embodiment. It is recognized, however, that departures may be made therefrom within the scope of the invention and that obvious modifications will occur to a person skilled in the art.

1. A real estate telecommunications system including a portable wireless electronic device adapted for providing a user, such as a real estate broker or market participant, with real estate related information, said system comprising:
a portable electronic device having an electronic display, said device capable of wireless data transmitting and receiving;
said device including a moving map GPS system capable of identifying individual properties and corresponding property locations and street address information;
input means for allowing the user to select at least one of said displayed properties;
wireless means for electronically communicating with a remote MLS database, obtaining real estate information relating to said selected property from said database, and displaying said information corresponding to said selected property.

2. A real estate telecommunications system according to claim 1, further including wireless means for electronically communicating with a property appraiser's database for obtaining real estate information for said selected property.

3. A real estate telecommunications system according to claim 1, further including wireless means for automatically accessing a comparable sales database for obtaining comparable sales information for said selected property.

4. A real estate telecommunications system according to claim 1, further including wireless means for electronically communicating with a real estate broker identified as a listing broker for said property.

5. A real estate telecommunications system according to claim 1, further including wireless means for electronically communicating with a database containing county records.

6. A real estate telecommunications system including a portable wireless device adapted for providing a user, such as a real estate broker or other market participant, with real estate related information, said system comprising:
a portable electronic device having an electronic display, said device capable of wireless data transmitting and receiving;
said device including a moving map GPS system capable of identifying individual properties, corresponding property locations and street address information;
input means for allowing the user to select one of said displayed properties;
wireless means for electronically communicating with a remote MLS database, obtaining real estate information relating to said selected property from said database, and displaying information corresponding to said selected property;
wireless means for electronically communicating with a property appraiser's database for obtaining real estate information for said selected property;
wireless means for automatically accessing a comparable sales database for obtaining comparable sales information for said selected property;
wireless means for electronically communicating with a real estate broker identified as a listing broker for said property.

7. A method for remotely obtaining real estate related information for use by brokers and other market participants, utilizing wireless electronic communication, said method comprising:
providing a portable electronic device having an electronic display, said device capable of wireless data transmitting and receiving and including a moving map GPS system;
enhancing a GPS database with geographical coordinate data corresponding to the actual locations of individual properties and corresponding street address information for said individual properties;
displaying moving map GPS information including display of icons corresponding to a plurality of properties in relation to said electronic device;
selecting at least one of said properties;
electronically communicating with a remote MLS database, obtaining real estate information relating to said a selected property from said database, and displaying information corresponding to said selected property.

8. A method for remotely obtaining real estate related information according to claim 7, further including wireless means for electronically communicating with a property appraiser's database for obtaining real estate information for said selected property.

9. A method for remotely obtaining real estate related information according to claim 7, further including wireless means for automatically accessing a comparable sales database for obtaining comparable sales information for said selected property.

10. A method for remotely obtaining real estate related information according to claim 7, further including wireless means for electronically communicating with a real estate broker identified as a listing broker for said property.

11. A method for remotely obtaining real estate related information according to claim 7, further including wireless means for electronically communicating with a database containing county records.

12. A method for remotely obtaining real estate related information according to claim 7, further including wireless means for electronically communicating with a database containing photographs of the selected property.

13. A method for remotely obtaining real estate related information according to claim 7, further including wireless means for electronically communicating with a database containing digitized images comprising a virtual tour of the selected property.

14. A method for remotely obtaining real estate related information according to claim 7, further including wireless means for electronically communicating with a database containing county records.
